(19) United States
(12) Patent Application Publication
(10) Pub. No.: US 2008/0239550 A1
(43) Pub. Date: Oct. 2, 2008

(54) Head slider, magnetic storage device and control circuit, having cleaning mechanism

(75) Inventor: Makoto Nagai, Kawasaki-shi (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/999,347

(22) Filed: Dec. 5, 2007

(30) Foreign Application Priority Data
Apr. 2, 2007 (JP) 2007-096777

(51) Int. Cl. G11B 21/02; G11B 5/60

(52) U.S. Cl. 360/75; 360/235.5

(57) ABSTRACT

The present invention relates to a head slider used for a magnetic storage device. In accordance with an aspect of the present invention, a head slider having an air bearing surface comprising, a heater element disposed at the air bearing surface, and at least one groove formed in an end surface at a trailing edge side of the head slider so as to extend toward a rear surface.

### BACKGROUND OF THE INVENTION

1. Field of the Invention

The present invention relates to a head slider used for a magnetic storage device.

2. Description of the Related Art

Magnetic storage devices like hard disk drives (HDDs) are widely used for business appliances such as business servers, workstations, and redundant arrays of inexpensive disks (RAID), and for home information appliances such as game machines, audio systems, mobile phones, and video recorders. A rapid growth in the market of magnetic storage devices is expected. In such magnetic storage devices, increase in recording density is desired. In particular, the HDDs are major magnetic storage devices since the unit price of a recording bit is inexpensive and the data transfer rate is fast as compared with other magnetic storage devices. The current recording density of the HDDs is increased at an annual rate ranging from 30% to 100%. Actually, mass-produced HDDs currently achieve an areal density of 100 Gb/in².

In this state, to increase the recording density of the magnetic storage device, it is important to reduce a height of a head slider with a magnetic head mounted when the head slider flies from a magnetic disk, that is, a flying height of the head slider. Reducing the flying height can enhance the output of an effective write signal obtained from the magnetic disk, and the intensity of an effective recording magnetic field of a write head element of the magnetic head mounted on the head slider, thereby realizing the increase in recording density.

In recent years, dynamic fly height (DFH) technique (also called thermal fly-height control, TFC) is suggested in which a thin-film heater mechanism made of, for example, copper (Cu) is formed in the vicinity of a read-write head element unit of the magnetic head mounted on the head slider, power is applied to the heater mechanism to generate heat, and the head slider is expanded due to the heat, thereby reducing the flying height. At this time, even when the power is not applied to the DFH heater, the flying height of the head slider is as extremely low as 10 nm.

In such a state where the flying height of the above-described head slider is reduced, not only the increase in recording density, but also a high HDI reliability are desired for the magnetic storage device. In particular, it is important to prevent contamination from being applied to the head slider and to the magnetic head mounted on the head slider caused by a contact between the head slider and the magnetic disk, and to prevent a contaminant generated in the magnetic storage device from adhering to the head slider. Note that the HDI reliability represents a reliability related to problems found at the interface (Interface) between the magnetic head (Head) mounted on the head slider and the disk (Disk).

Regarding such circumstances, an object of the present invention is to provide a cleaning mechanism of a head slider to comply with a high HDI reliability. Another object is to provide a cleaning mechanism of a head slider by a method without a load applied to a read-write head element unit. Still another object is to provide a cleaning mechanism of a head slider without an adhering substance on a head slider scattered on a magnetic disk.

### SUMMARY

In accordance with an aspect of an embodiment, a head slider has an air bearing surface that includes, a heater element disposed at the air bearing surface, and at least one groove formed in an end surface at a trailing edge side of the head slider so as to extend toward a rear surface.

### BRIEF DESCRIPTION OF THE DRAWINGS

FIG. 1 is an illustration showing the inside of a magnetic storage device which uses an exemplary head slider according to a first embodiment of the present invention;

FIG. 2 is an illustration showing an air bearing surface of a head slider of a related art which is a comparative configuration of the first embodiment;

FIG. 3 is an illustration showing a state where an adhering substance is accumulated on the head slider of the related art;

FIG. 4 is an illustration showing an air bearing surface of the head slider according to the first embodiment;

FIG. 5 is an illustration showing a side surface of the head slider according to the first embodiment;

FIG. 6 is an end view showing a trailing edge of the head slider according to the first embodiment;

FIG. 7 is an illustration showing an air bearing surface of a head slider according to a second embodiment of the present invention;

FIG. 8 is an illustration showing a control diagram for controlling the head slider according to the first or second embodiment.

### DESCRIPTION OF THE PREFERRED EMBODIMENTS

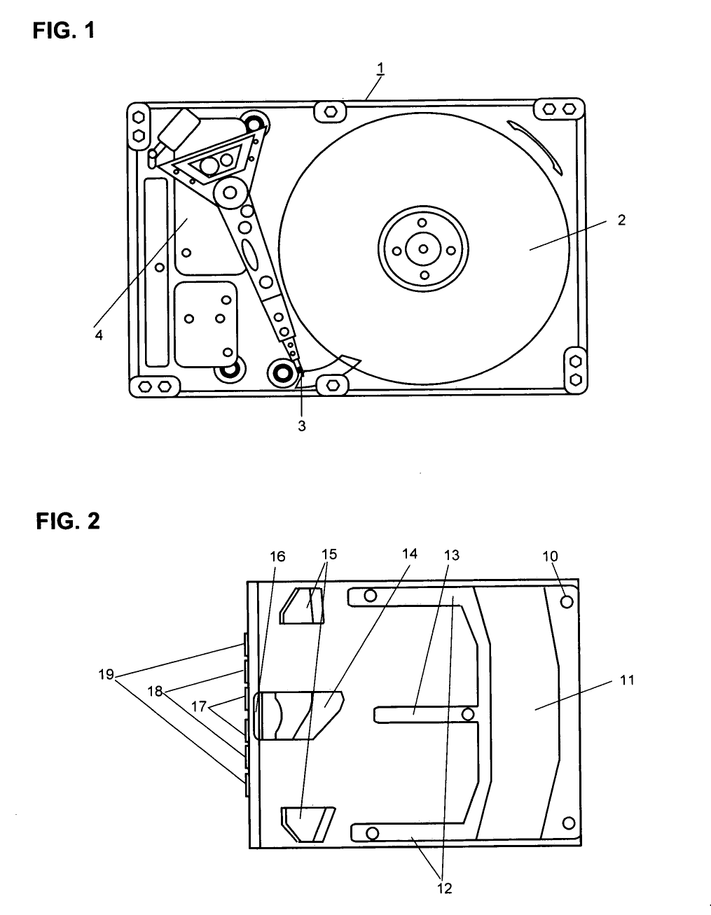

Embodiments of the present invention are described below with reference to FIGS. 1 to 8. FIG. 1 is a schematic illustration showing the inside of a typical magnetic storage device which uses an exemplary head slider according to a first embodiment of the present invention. A magnetic storage device 1 has therein a magnetic disk 2 serving as a read-write medium, a head slider 3 to which a magnetic head is mounted, and a head amplifier IC 4 which controls read and write signals and supplies power to the magnetic head. FIG. 2 is an illustration showing an air bearing surface (ABS) of a head slider of a related art for comparison with the first embodiment. A front rail 11 with a thickness of 2.0 μm is formed on an alumina-titanium carbide (AlTiC) substrate made of Al₂O₃—Ti—C. Also, side rails 12, a center rail 13 and rear rails 15 are formed. A center rear rail 14 is formed in the vicinity of the center of the trailing edge, which is provided with a read-write head element unit 16 of the magnetic head. In general, the rails are formed by cutting using focused ion beam (FIB). Though not shown, a DFH heater made of, for example, a Cu thin film, may be formed in the vicinity of the read-write head element unit 16.

The rails of the head slider may have protection pads 10 made of diamond-like carbon (DLC) to prevent the rails from being stuck to a magnetic disk. DFH heater terminals 19, as well as read terminals 17 and write terminals 18 for applying a voltage to the read-write head element unit, are disposed at an upper portion of an end surface at the trailing edge of the head slider.

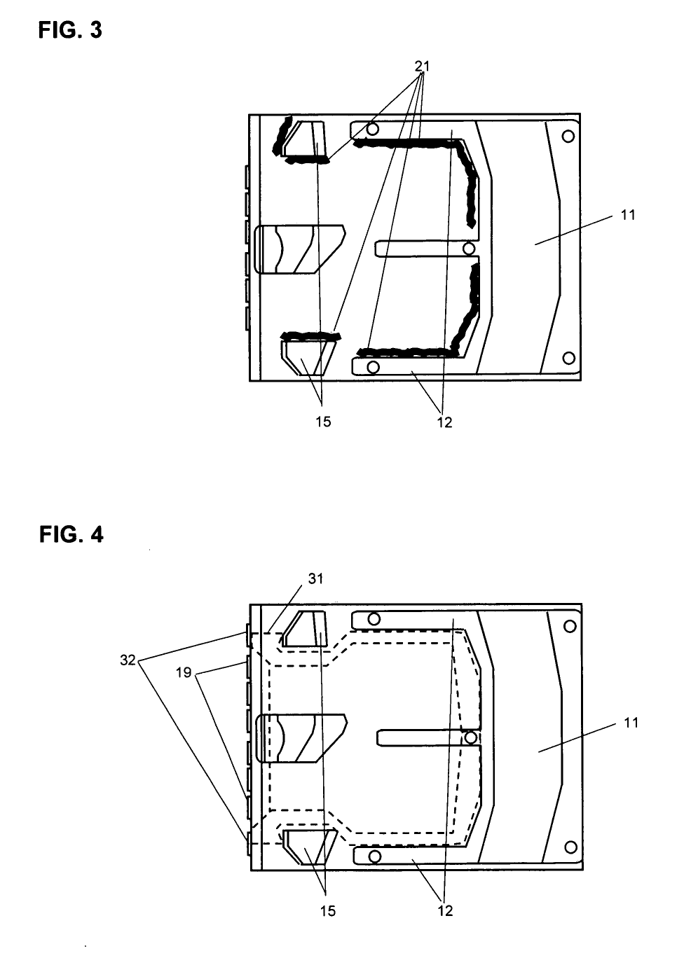

FIG. 3 is an illustration showing a state where an adhering substance is accumulated on the head slider of the related art. As shown in FIG. 3, an adhering substance 21 may be accumulated on a portion where a negative pressure increases when the head slider flies, namely, on end portions of the rails. (The adhering substance 21 typically includes a lubricant and a contaminant.)

FIG. 4 is an illustration showing an air bearing surface of the head slider according to the first embodiment of the present invention. A heater element 31 made of, for example, Cu, is provided in the head slider at the rails at which the adhering substance 21 may be easily accumulated, that is, at the portion where the negative pressure increases when the head slider flies. In particular, the thin-film heater element 31 is disposed in the head slider so as to extend along the end portions of the front rail 11, side rails 12, and rear rails 15. To be more specific, the thin-film heater element 31 made of Cu is disposed in the head slider so as to extend along the inner side of the front rail disposed near a leading edge of the head slider and serving as an air bearing surface, along the inner sides of the side rails disposed from near the leading edge toward the trailing edge, along the inner sides of the rear rails disposed near the trailing edge, and along an end portion near the trailing edge. The inner side of the front rail is oriented in a direction toward the trailing edge. Also, the inner sides of the side rails are respectively oriented toward the center of the head slider. (In FIG. 4, the heater element 31 is illustrated on the surface so as to clarify the positional relationship between the rails and the heater element 31.) Such a shape can minimize power consumption and allows the viscosity of the adhering substance 21 to be reduced. For applying power to the heater element 31, heater element terminals 32 are arranged next to the DFH heater terminals 19. With this arrangement, wiring to a head amplifier may employ an existing technique of wiring, thereby facilitating the wiring. In a case where the DFH heater applies heat to the read-write head element unit, the heater element 31 does not have to be provided in the vicinity of the read-write head element unit. Because DFH heater can reduce the viscosity of the adhering substance around the read-write element.

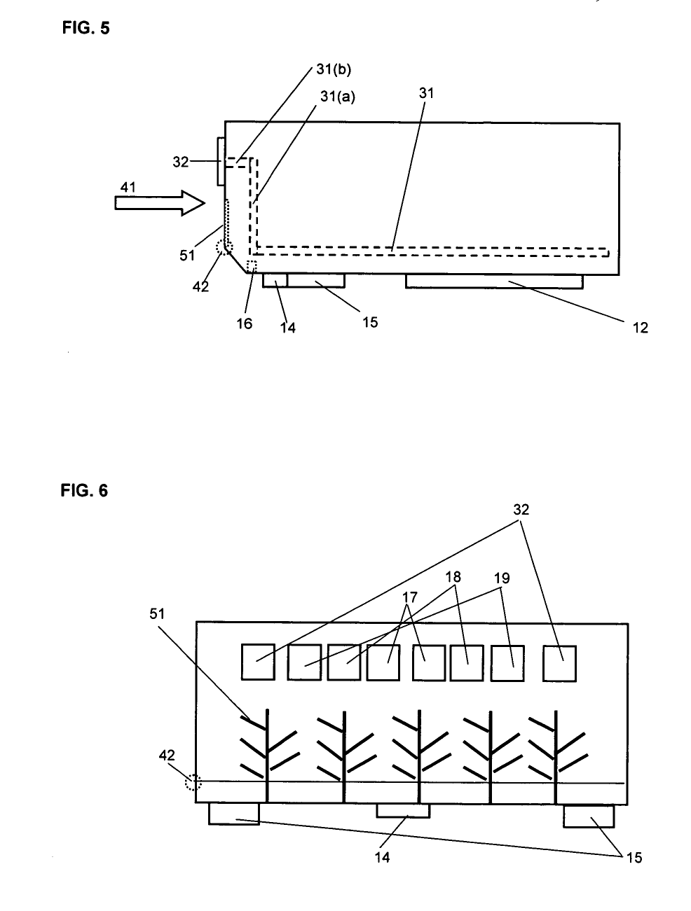

FIG. 5 is an illustration showing a side surface of the head slider according to the first embodiment. The heater element 31 has a thickness of about 2.0 μm, is provided at a height of about 3.5 μm from the air bearing surface of the head slider, and is connected to the heater element terminals 32 disposed at a trailing edge side 41. Now, an embodiment is described in which the heater element 31 is provided in the head slider. An AlTiC wafer made of Al₂O₃—Ti—C is cut into bars, and then a groove is made by cutting using FIB at the AlTiC substrate made of Al₂O₃—Ti—C to become the head slider, so as to provide the heater element having a desired shape, that is, to provide the heater element extending along the rails which are formed later. Next, for example, copper (Cu) is accumulated in the cut groove by plating to form the heater element 31. Next, a non-conductive material (for example, Al₂O₃—Ti—C material) is deposited, for example, by radio frequency (RF) sputtering to cap the groove cut using FIB. Next, surface polishing is performed by chemical mechanical polish (CMP). Then, a typical magnetic head and the rails of the head slider are formed. First joint portions 31(a) for joining the heater element 31 to the heater element terminals 32 are formed by photolithography and plating while being isolated using alumina, at the same time when the read-write head element unit 16 is formed by a known method. Second joint portions 31(b) may be formed by a method similar to that for joining a read head element to the read terminals 17, and that for joining a write head element to the write terminals 18.

FIG. 6 is an end view showing the trailing edge side of the head slider according to the first embodiment. The read terminals 17, the write terminals 18, the DFH heater terminals 19, and the heater element terminals 32 are arranged parallel to each other on the end surface at the trailing edge side. Grooves are formed in a chamfered surface of the end surface of the head slider, or in the end surface to extend from an upper slider edge 42, for example, by using above-mentioned FIB. The grooves each have a width ranging from about 5 to 100 μm, and a depth ranging from about 5 to 100 μm. If the size of the grooves exceeds the above-mentioned size, then a capillary action may not be basically generated. By forming the grooves, the grooves can absorb the adhering substance flowing toward the trailing edge side due to an airflow caused by rotation of a magnetic disk, by utilizing the capillary action. In the embodiment of the present invention, each groove is processed such that the groove has a fish-bone-like shape. Such a shape of the groove allows the total area of the grooves to become large, thereby increasing the amount of lubricant in the adhering substance that is absorbed.

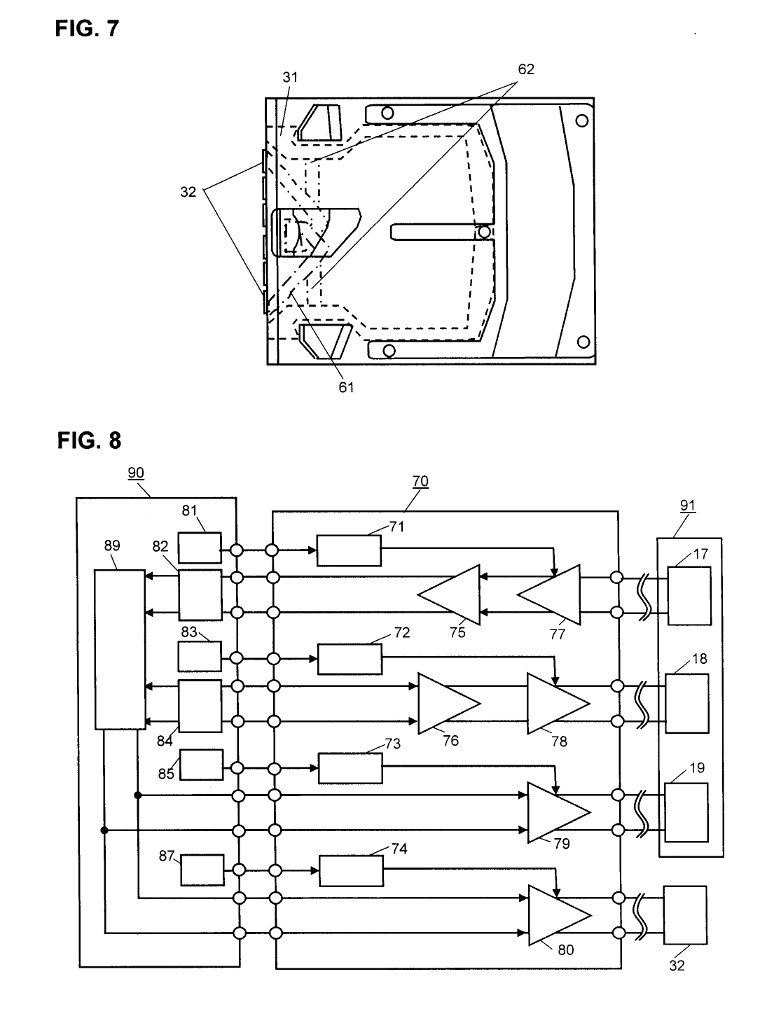

FIG. 7 is an illustration showing an air bearing surface of a head slider according to a second embodiment of the present invention. A DFH heater 61 may be connected to the heater element 31 with a bridge plate 62 made of, for example, Cu, interposed therebetween. With this configuration, the DFH heater 61 and the heater element 31 can share the heater element terminals 32. In such a case, as described above, the read-write head element unit 16 can be heated by the DFH heater 61. This may provide an advantage because the heater element 31 does not have to be provided in the vicinity of the read-write head element unit 16.

As described above, with the head slider according to the first or second embodiment, the viscosity of the adhering substance on the head slider can be reduced by heating the head slider using heat applied by the heater element, or heat applied by both the heater element and the DFH heater, when a read operation or a write operation of a magnetic head mounted on the head slider is not performed. Meanwhile, an airflow generated between the head slider and the magnetic disk flows toward the trailing edge side of the head slider. Because of this, the adhering substance with a reduced viscosity flows toward the trailing edge side of the head slider. At this time, the adhering substance moves up through the grooves provided at the end surface at the trailing edge side of the head slider due to the capillary action of the grooves. With this action, the head slider, and the magnetic head mounted on the head slider can be cleaned up.

In particular, the entire head slider including the magnetic head can be cleaned up without a load applied to the read-write head element unit of the magnetic head mounted on the head slider, or without the adhering substance of the head slider scattered on the magnetic head. By using the head slider having such a cleaning mechanism, a magnetic storage device having a high HDI reliability can be provided.

FIG. 8 illustrates a control diagram for controlling the head slider according to the first or second embodiment. In order to perform general read and write processes, a read power supply 71, a read data buffer 75, and a read amplifier 77, for controlling the read head element, as well as a write power supply 72, a write data buffer 76, and a write driver 78, for controlling the write head element, are mounted in a head amplifier IC 70. The read amplifier 77 is connected to the read terminal 17 of the read head element of a magnetic head 91. Also, the write driver 78 is connected to the write terminal 18 of the write head element. In addition, a DFH heater power supply 73 and a DFH heater driver 79 are mounted in the head amplifier IC 70. The DFH heater driver 79 is connected to the DFH heater terminal 19. Also, a heater element power supply 74 and a heater element driver 80 are mounted. The DFH heater power supply 73 and the heater element power supply 74 may have configurations similar to those of the read power supply 71 and the write power supply 72. The heater element driver 80 is connected to the heater element terminal 32.

A decoder 82 of a read-write channel LSI 90 has a function of decoding read data received from the read data buffer 75. The read operation is performed such that a read signal obtained from a magnetic disk is amplified by the read amplifier 77, the amplified signal passes through the read data buffer 75, and the data is transmitted to the read-write channel LSI 90. At this time, power is applied to the read terminal 17 from a read voltage regulator 81 through the read power supply 71. The write operation is performed such that write data is coded by an encoder 84, the coded write data is transmitted to the write data buffer 76 disposed in the head amplifier IC 70, the write data passes through the write driver 78 and then the write terminal 18, and a write magnetic field is applied by the write head element. At this time, power is applied to the write terminal 18 from a write voltage regulator 83 through the write power supply 72. Though not shown, the decoder 82 and the encoder 84 are connected to a finite impulse response (FIR) filter, a Viterbi decoder, and the like. Also, a DFH heater voltage regulator 85 and a heater element voltage regulator 87 are provided in the read-write channel LSI 90, and provide functions similar to those of the above-described read voltage regulator 81 and the write voltage regulator 83.

A heater element control circuit 89 is disposed in the read-write channel LSI 90. The heater element control circuit 89 operates only the heater element driver 80, or both the heater element driver 80 and the DFH heater driver 79 for cleaning up when the decoder 82 and the encoder 84 do not detect reception and transmission of signals and when the magnetic head 91 does not perform the read operation or the write operation. Alternatively, the heater element control circuit 89 may be disposed in the head amplifier IC 70, or it may be independently disposed in a manner connecting the read-write channel LSI 90 and the head amplifier IC 70.

With the configuration according to the first or second embodiment, the magnetic head can be cleaned up by a method without a load applied to the read-write head element unit, or without the adhering substance scattered on the magnetic head. Accordingly, a magnetic storage device having a high HDI reliability can be provided.

The head slider of these embodiments can be used by various types of heads, such as a magnetic head for longitudinal magnetic recording, a magnetic head for perpendicular magnetic recording, a magnetic head for magneto-optical recording, and the like.

What is claimed is:

1. A head slider having an air bearing surface, comprising:
a heater element disposed at the air bearing surface; and
at least one groove formed in an end surface at a trailing edge side of the head slider so as to extend toward a rear surface.

2. The head slider according to claim 1, wherein the heater element is provided parallel to the air bearing surface, and is disposed at the air bearing surface in a region having a high negative pressure.

3. The head slider according to claim 1, wherein the groove has a fish-bone-like shape.

4. The head slider according to claim 1, wherein the heater element is covered with a non-conductive material.

5. The head slider according to claim 2, wherein the heater element is covered with a non-conductive material.

6. The head slider according to claim 1, wherein a terminal which allows power to be applied to the heater element is disposed on the end surface at the trailing edge side.

7. The head slider according to claim 1, wherein the groove with a width and depth ranging from 5 to 100 μm.

8. The head slider according to claim 3, wherein the groove has a width and depth ranging from 5 to 100 μm.

9. A magnetic storage device comprising:
a magnetic head mounted on a head slider having an air bearing surface, the head slider including
a heater element disposed at the air bearing surface, and
at least one groove formed in an end surface at a trailing edge side of the head slider so as to extend in a vertical direction; and
a magnetic disk as a read-write medium.

10. The magnetic storage device according to claim 9, wherein when the head slider flies, heat generated by the heater element reduces a viscosity of an adhering substance on the head slider, an airflow generated by rotation of the magnetic disk transfers the adhering substance toward the trailing edge side of the head slider, and the groove absorbs the adhering substance utilizing a capillary action, so as to clean up the head slider.

11. The magnetic storage device according to claim 10, wherein the viscosity of the adhering substance is reduced by using both the heater element and a DFH heater provided in the vicinity of a read-write head element unit, so as to clean up the head slider.

12. A control circuit comprising:
a heater element control circuit which detects whether or not a read operation or a write operation of a magnetic head is performed; and
a heater element driver allows a heater element to generate heat when the read operation or the write operation is not performed.
